(19) United States
(12) Patent Application Publication
(10) Pub. No.: US 2008/0248867 A1
(43) Pub. Date: Oct. 9, 2008

(54) WAGERING GAME INSURANCE

(76) Inventors: Allon G. Englman, Chicago, IL (US); Rob L. Kyte, Chicago, IL (US); Michael W. Mastropietro, Chicago, IL (US)

Correspondence Address: NIXON PEABODY LLP, 161 N CLARK ST., 48TH FLOOR, CHICAGO, IL, 60601-3213, US

(21) Appl. No.: 12/061,500

(22) Filed: Apr. 2, 2008

Related U.S. Application Data
(60) Provisional application No. 60/921,689, filed on Apr. 4, 2007.

(51) Int. Cl. A63F 13/00

(52) U.S. Cl. 463/25

(57) ABSTRACT

A gaming system for conducting a wagering game includes a value input device adapted to receive an input value corresponding to a wager to enable the play of a wagering game. A display is configured to display a randomly determined outcome and a controller is operative to accept a redemption of wagering insurance in association with the randomly determined outcome prior to a reveal of the randomly determined outcome and is operative to alter at least one aspect of the wagering game consistent with a condition defined by the wagering insurance.

### CROSS REFERENCE TO RELATED APPLICATIONS

This application claims the priority of U.S. Provisional Patent Application No. 60/921,689, filed Apr. 4, 2007, entitled “Wagering Game Insurance” which is incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and methods for playing wagering games, and more particularly, to systems and methods for providing wagering game insurance.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

One concept that has been successfully employed to enhance the entertainment value of a game is the concept of a “secondary” or “bonus” game that may be played in conjunction with a “basic” game. The bonus game may comprise any type of game, either similar to or completely different from the basic game, which is entered upon the occurrence of a selected event or outcome in the basic game. Generally, bonus games provide a greater expectation of winning than the basic game and may also be accompanied with more attractive or unusual video displays and/or audio. Bonus games may additionally award players with “progressive jackpot” awards that are funded, at least in part, by a percentage of coin-in from the gaming machine or a plurality of participating gaming machines. Because the bonus game concept offers tremendous advantages in player appeal and excitement relative to other known games, and because such games are attractive to both players and operators, there is a continuing need to develop gaming machines with new types of bonus games to satisfy the demands of players and operators.

### SUMMARY OF THE INVENTION

According to one aspect of the present concepts, a gaming system for conducting a wagering game includes a value input device adapted to receive an input value corresponding to a wager to enable the play of a wagering game. A display is configured to display a randomly determined outcome and a controller is operative to accept a redemption of wagering insurance in association with the randomly determined outcome prior to a reveal of the randomly determined outcome and is operative to alter at least one aspect of the wagering game consistent with a condition defined by the wagering insurance.

According to another aspect of the present concepts, a method of conducting a wagering game on a gaming system comprises the acts of providing a player with at least one option to alter a configuration of a wagering game and determining, responsive to a selection of an option for the altering of a wagering game configuration, a change to the expected value corresponding to the selected option. The method also includes the acts of assessing to the player a cost relating to the determined change in the expected value and conducting the wagering game consistent with an altered configuration corresponding to the selected option.

A method of conducting a wagering game on a gaming machine in accord with yet additional aspects of the present concepts includes the acts of prompting a player to redeem at least one unit of wagering insurance and altering, responsive to the redeeming of at least one unit of wagering insurance, a configuration of a wagering game on the gaming machine from a first configuration to a second configuration in accord with one or more conditions associated with the redeemed wagering insurance. The method also includes the acts of conducting the wagering game consistent with the altered configuration, satisfying an expiration condition for the redeemed wagering insurance, and returning the configuration of the wagering game on the gaming machine from the second configuration to the first configuration responsive to the satisfying of the expiration condition for the redeemed wagering insurance.

A method of conducting a wagering game on a gaming machine in accord with further aspects of the present concepts includes the act of providing a player with an option to replay a wagering game if an outcome associated with said wagering game fails to meet a threshold outcome. The method also includes the acts of determining a change to the expected value of the wagering game corresponding to the selected option, charging the player a cost relating to the determined change in the expected value, and randomly determining an outcome of the wagering game.

According to yet another aspect of the invention, a computer readable storage medium is encoded with instructions for directing a gaming system to perform any of the above methods.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1a is a perspective view of a free standing gaming machine embodying the present invention;

FIG. 1b is a perspective view of a handheld gaming machine embodying the present invention;

FIG. 2 is a block diagram of a control system suitable for operating the gaming machines of FIGS. 1a and 1b;

FIGS. 3a-3b show an example of tables embodying calculations of a type representative of at least some aspects of the present concepts;

FIGS. 4a-4e show an example of wagering insurance applied to a picking-themed bonus game in accord with at least some aspects of the present concepts;

FIGS. 5a-5d show another example of wagering insurance applied to a picking-themed bonus game in accord with at least some aspects of the present concepts;

FIG. 6 depicts a method in accord with at least some aspects of the present concepts;

FIG. 7 depicts another method in accord with at least some aspects of the present concepts.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

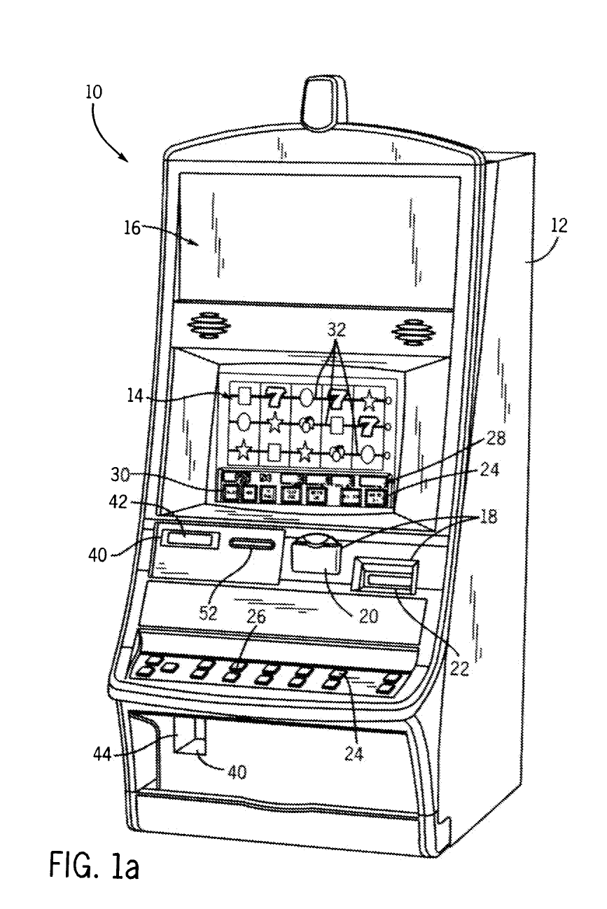

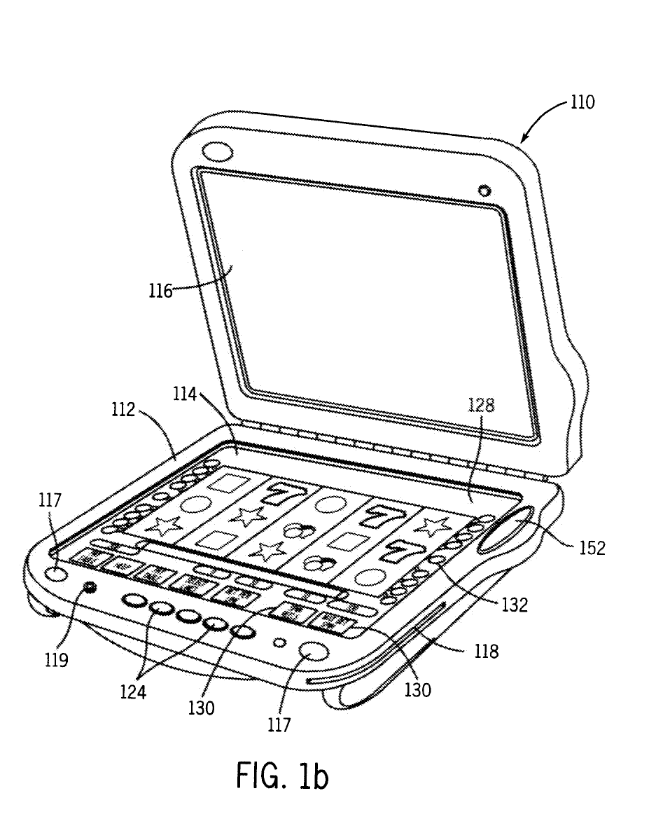

Referring to FIG. 1a, a gaming machine 10 is used in gaming establishments such as casinos. With regard to the present invention, the gaming machine 10 may be any type of gaming machine and may have varying structures and methods of operation. For example, the gaming machine 10 may be an electromechanical gaming machine configured to play mechanical slots, or it may be an electronic gaming machine configured to play a video casino game, such as slots, keno, poker, blackjack, roulette, etc.

The gaming machine 10 comprises a housing 12 and includes input devices, including a value input device 18 and a player input device 24. For output the gaming machine 10 includes a primary display 14 for displaying information about the basic wagering game. The primary display 14 can also display information about a bonus wagering game and a progressive wagering game. The gaming machine 10 may also include a secondary display 16 for displaying game events, game outcomes, and/or signage information. While these typical components found in the gaming machine 10 are described below, it should be understood that numerous other elements may exist and may be used in any number of combinations to create various forms of a gaming machine 10.

The value input device 18 may be provided in many forms, individually or in combination, and is preferably located on the front of the housing 12. The value input device 18 receives currency and/or credits that are inserted by a player. The value input device 18 may include a coin acceptor 20 for receiving coin currency (see FIG. 1a). Alternatively, or in addition, the value input device 18 may include a bill acceptor 22 for receiving paper currency. Furthermore, the value input device 18 may include a ticket reader, or barcode scanner, for reading information stored on a credit ticket, a card, a biometric reader, or other tangible portable credit storage device (e.g., electronic wallet, fob, etc.). The credit ticket or card may also authorize access to a central account, which can transfer money to the gaming machine 10.

The player input device 24 comprises a plurality of push buttons 26 on a button panel for operating the gaming machine 10. In addition, or alternatively, the player input device 24 may comprise a touch screen 28 mounted by adhesive, tape, or the like over the primary display 14 and/or secondary display 16. The touch screen 28 contains soft touch keys 30 denoted by graphics on the underlying primary display 14 and used to operate the gaming machine 10. The touch screen 28 provides players with an alternative method of input. A player enables a desired function either by touching the touch screen 28 at an appropriate touch key 30 or by pressing an appropriate push button 26 on the button panel. The touch keys 30 may be used to implement the same functions as push buttons 26. Alternatively, the push buttons 26 may provide inputs for one aspect of the operating the game, while the touch keys 30 may allow for input needed for another aspect of the game.

The various components of the gaming machine 10 may be connected directly to, or contained within, the housing 12, as seen in FIG. 1a, or may be located outboard of the housing 12 and connected to the housing 12 via a variety of different wired or wireless connection methods. Thus, the gaming machine 10 comprises these components whether housed in the housing 12, or outboard of the housing 12 and connected remotely.

The operation of the basic wagering game is displayed to the player on the primary display 14. The primary display 14 can also display the bonus game associated with the basic wagering game. The primary display 14 may take the form of a cathode ray tube (CRT), a high resolution LCD, a plasma display, an LED, or any other type of display suitable for use in the gaming machine 10. As shown, the primary display 14 includes the touch screen 28 overlaying the entire display (or a portion thereof) to allow players to make game-related selections. Alternatively, the primary display 14 of the gaming machine 10 may include a number of mechanical reels to display the outcome in visual association with at least one payline 32. In the illustrated embodiment, the gaming machine 10 is an “upright” version in which the primary display 14 is oriented vertically relative to the player. Alternatively, the gaming machine may be a “slant-top” version in which the primary display 14 is slanted at about a thirty-degree angle toward the player of the gaming machine 10.

A player begins play of the basic wagering game by making a wager via the value input device 18 of the gaming machine 10. A player can select play by using the player input device 24, via the buttons 26 or the touch screen keys 30. The basic game consists of a plurality of symbols arranged in an array, and includes at least one payline 32 that indicates one or more outcomes of the basic game. Such outcomes are randomly selected in response to the wagering input by the player. At least one of the plurality of randomly-selected outcomes may be a start-bonus outcome, which can include any variations of symbols or symbol combinations triggering a bonus game.

In some embodiments, the gaming machine 10 may also include a player information reader 52 that allows for identification of a player by reading a card with information indicating his or her true identity. The player information reader 52 is shown in FIG. 1a as a card reader, but may take on many forms including a ticket reader, bar code scanner, RFID transceiver or computer readable storage medium interface. Currently, identification is generally used by casinos for rewarding certain players with complimentary services or special offers. For example, a player may be enrolled in the gaming establishment's loyalty club and may be awarded certain complimentary services as that player collects points in his or her player-tracking account. The player inserts his or her card into the player information reader 52, which allows the casino's computers to register that player's wagering at the gaming machine 10. The gaming machine 10 may use the secondary display 16 or other dedicated player-tracking display for providing the player with information about his or her account or other player-specific information. Also, in some embodiments, the information reader 52 may be used to restore game assets that the player achieved and saved during a previous game session.

Depicted in FIG. 1b is a handheld or mobile gaming machine 110. Like the free standing gaming machine 10, the handheld gaming machine 110 is preferably an electronic gaming machine configured to play a video casino game such as, but not limited to, slots, keno, poker, blackjack, and roulette. The handheld gaming machine 110 comprises a housing or casing 112 and includes input devices, including a value input device 118 and a player input device 124. For output the handheld gaming machine 110 includes, but is not limited to, a primary display 114, a secondary display 116, one or more speakers 117, one or more player-accessible ports 119 (e.g, an audio output jack for headphones, a video headset jack, etc.), and other conventional I/O devices and ports, which may or may not be player-accessible. In the embodiment depicted in FIG. 1b, the handheld gaming machine 110 comprises a secondary display 116 that is rotatable relative to the primary display 114. The optional secondary display 116 may be fixed, movable, and/or detachable/attachable relative to the primary display 114. Either the primary display 114 and/or secondary display 116 may be configured to display any aspect of a non-wagering game, wagering game, secondary games, bonus games, progressive wagering games, group games, shared-experience games or events, game events, game outcomes, scrolling information, text messaging, emails, alerts or announcements, broadcast information, subscription information, and handheld gaming machine status.

The player-accessible value input device 118 may comprise, for example, a slot located on the front, side, or top of the casing 112 configured to receive credit from a stored-value card (e.g., casino card, smart card, debit card, credit card, etc.) inserted by a player. In another aspect, the player-accessible value input device 118 may comprise a sensor (e.g., an RF sensor) configured to sense a signal (e.g., an RF signal) output by a transmitter (e.g., an RF transmitter) carried by a player. The player-accessible value input device 118 may also or alternatively include a ticket reader, or barcode scanner, for reading information stored on a credit ticket, a card, or other tangible portable credit or funds storage device. The credit ticket or card may also authorize access to a central account, which can transfer money to the handheld gaming machine 110.

Still other player-accessible value input devices 118 may require the use of touch keys 130 on the touch-screen display (e.g., primary display 114 and/or secondary display 116) or player input devices 124. Upon entry of player identification information and, preferably, secondary authorization information (e.g., a password, PIN number, stored value card number, predefined key sequences, etc.), the player may be permitted to access a player's account. As one potential optional security feature, the handheld gaming machine 110 may be configured to permit a player to only access an account the player has specifically set up for the handheld gaming machine 110. Other conventional security features may also be utilized to, for example, prevent unauthorized access to a player's account, to minimize an impact of any unauthorized access to a player's account, or to prevent unauthorized access to any personal information or funds temporarily stored on the handheld gaming machine 110.

The player-accessible value input device 118 may itself comprise or utilize a biometric player information reader which permits the player to access available funds on a player's account, either alone or in combination with another of the aforementioned player-accessible value input devices 118. In an embodiment wherein the player-accessible value input device 118 comprises a biometric player information reader, transactions such as an input of value to the handheld device, a transfer of value from one player account or source to an account associated with the handheld gaming machine 110, or the execution of another transaction, for example, could all be authorized by a biometric reading, which could comprise a plurality of biometric readings, from the biometric device.

Alternatively, to enhance security, a transaction may be optionally enabled only by a two-step process in which a secondary source confirms the identity indicated by a primary source. For example, a player-accessible value input device 118 comprising a biometric player information reader may require a confirmatory entry from another biometric player information reader 152, or from another source, such as a credit card, debit card, player ID card, fob key, PIN number, password, hotel room key, etc. Thus, a transaction may be enabled by, for example, a combination of the personal identification input (e.g., biometric input) with a secret PIN number, or a combination of a biometric input with a fob input, or a combination of a fob input with a PIN number, or a combination of a credit card input with a biometric input. Essentially, any two independent sources of identity, one of which is secure or personal to the player (e.g., biometric readings, PIN number, password, etc.) could be utilized to provide enhanced security prior to the electronic transfer of any funds. In another aspect, the value input device 118 may be provided remotely from the handheld gaming machine 110.

The player input device 124 comprises a plurality of push buttons on a button panel for operating the handheld gaming machine 110. In addition, or alternatively, the player input device 124 may comprise a touch screen 128 mounted to a primary display 114 and/or secondary display 116. In one aspect, the touch screen 128 is matched to a display screen having one or more selectable touch keys 130 selectable by a user's touching of the associated area of the screen using a finger or a tool, such as a stylus pointer. A player enables a desired function either by touching the touch screen 128 at an appropriate touch key 130 or by pressing an appropriate push button 126 on the button panel. The touch keys 130 may be used to implement the same functions as push buttons 126. Alternatively, the push buttons may provide inputs for one aspect of the operating the game, while the touch keys 130 may allow for input needed for another aspect of the game. The various components of the handheld gaming machine 10 may be connected directly to, or contained within, the casing 112, as seen in FIG. 1b, or may be located outboard of the casing 112 and connected to the casing 112 via a variety of hardwired (tethered) or wireless connection methods. Thus, the handheld gaming machine 110 may comprise a single unit or a plurality of interconnected parts (e.g., wireless connections) which may be arranged to suit a player's preferences.

The operation of the basic wagering game on the handheld gaming machine 110 is displayed to the player on the primary display 114. The primary display 114 can also display the bonus game associated with the basic wagering game. The primary display 114 preferably takes the form of a high resolution LCD, a plasma display, an LED, or any other type of display suitable for use in the handheld gaming machine 110. The size of the primary display 114 may vary from, for example, about a 2-3″ display to a 15″ or 17″ display. In at least some aspects, the primary display 114 is a 7″-10″ display. As the weight of and/or power requirements of such displays decreases with improvements in technology, it is envisaged that the size of the primary display may be increased. Optionally, coatings or removable films or sheets may be applied to the display to provide desired characteristics (e.g., anti-scratch, anti-glare, bacterially-resistant and anti-microbial films, etc.). In at least some embodiments, the primary display 114 and/or secondary display 116 may have a 16:9 aspect ratio or other aspect ratio (e.g., 4:3). The primary display 114 and/or secondary display 116 may also each have different resolutions, different color schemes, and different aspect ratios.

As with the free standing gaming machine 10, a player begins play of the basic wagering game on the handheld gaming machine 110 by making a wager (e.g., via the value input device 18 or an assignment of credits stored on the handheld gaming machine via the touch screen keys 130, player input device 124, or buttons 126) on the handheld gaming machine 110. In at least some aspects, the basic game may comprise a plurality of symbols arranged in an array, and includes at least one payline 132 that indicates one or more outcomes of the basic game. Such outcomes are randomly selected in response to the wagering input by the player. At least one of the plurality of randomly selected outcomes may be a start-bonus outcome, which can include any variations of symbols or symbol combinations triggering a bonus game.

In some embodiments, the player-accessible value input device 118 of the handheld gaming machine 110 may double as a player information reader 152 that allows for identification of a player by reading a card with information indicating the player's identity (e.g., reading a player's credit card, player ID card, smart card, etc.). The player information reader 152 may alternatively or also comprise a bar code scanner, RFID transceiver or computer readable storage medium interface. In one presently preferred aspect, the player information reader 152, shown by way of example in FIG. 1b, comprises a biometric sensing device.

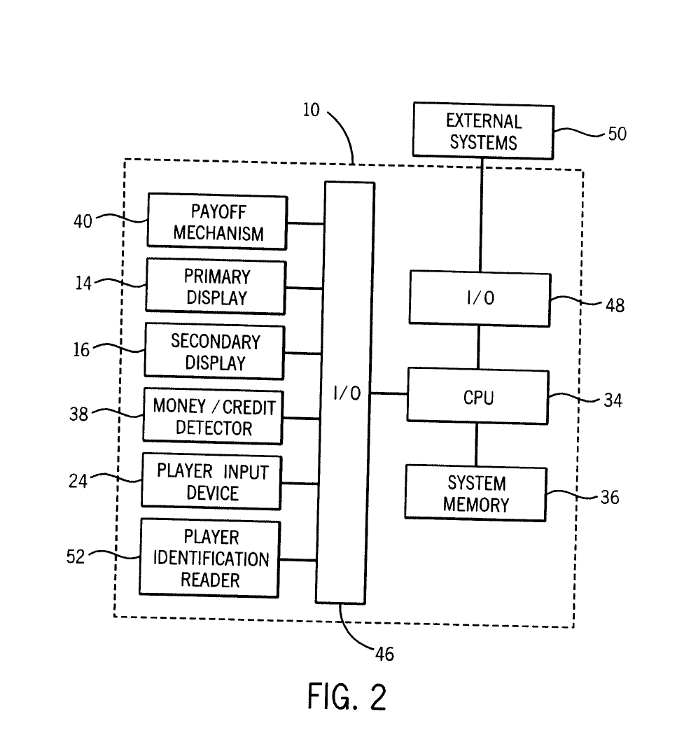

Turning now to FIG. 2, the various components of the gaming machine 10 are controlled by a central processing unit (CPU) 34, also referred to herein as a controller or processor (such as a microcontroller or microprocessor). To provide gaming functions, the controller 34 executes one or more game programs stored in a computer readable storage medium, in the form of memory 36. The controller 34 performs the random selection (using a random number generator (RNG)) of an outcome from the plurality of possible outcomes of the wagering game. Alternatively, the random event may be determined at a remote controller. The remote controller may use either an RNG or pooling scheme for its central determination of a game outcome. It should be appreciated that the controller 34 may include one or more microprocessors, including but not limited to a master processor, a slave processor, and a secondary or parallel processor.

The controller 34 is also coupled to the system memory 36 and a money/credit detector 38. The system memory 36 may comprise a volatile memory (e.g., a random-access memory (RAM)) and a non-volatile memory (e.g., an EEPROM). The system memory 36 may include multiple RAM and multiple program memories. The money/credit detector 38 signals the processor that money and/or credits have been input via the value input device 18. Preferably, these components are located within the housing 12 of the gaming machine 10. However, as explained above, these components may be located outboard of the housing 12 and connected to the remainder of the components of the gaming machine 10 via a variety of different wired or wireless connection methods.

As seen in FIG. 2, the controller 34 is also connected to, and controls, the primary display 14, the player input device 24, and a payoff mechanism 40. The payoff mechanism 40 is operable in response to instructions from the controller 34 to award a payoff to the player in response to certain winning outcomes that might occur in the basic game or the bonus game(s). The payoff may be provided in the form of points, bills, tickets, coupons, cards, etc. For example, in FIG. 1a, the payoff mechanism 40 includes both a ticket printer 42 and a coin outlet 44. However, any of a variety of payoff mechanisms 40 well known in the art may be implemented, including cards, coins, tickets, smartcards, cash, etc. The payoff amounts distributed by the payoff mechanism 40 are determined by one or more pay tables stored in the system memory 36.

Communications between the controller 34 and both the peripheral components of the gaming machine 10 and external systems 50 occur through input/output (I/O) circuits 46, 48. More specifically, the controller 34 controls and receives inputs from the peripheral components of the gaming machine 10 through the input/output circuits 46. Further, the controller 34 communicates with the external systems 50 via the I/O circuits 48 and a communication path (e.g., serial, parallel, IR, RC, 10bT, etc.). The external systems 50 may include a gaming network, other gaming machines, a gaming server, communications hardware, or a variety of other interfaced systems or components. Although the I/O circuits 46, 48 may be shown as a single block, it should be appreciated that each of the I/O circuits 46, 48 may include a number of different types of I/O circuits.

Controller 34, as used herein, comprises any combination of hardware, software, and/or firmware that may be disposed or resident inside and/or outside of the gaming machine 10 that may communicate with and/or control the transfer of data between the gaming machine 10 and a bus, another computer, processor, or device and/or a service and/or a network. The controller 34 may comprise one or more controllers or processors. In FIG. 2, the controller 34 in the gaming machine 10 is depicted as comprising a CPU, but the controller 34 may alternatively comprise a CPU in combination with other components, such as the I/O circuits 46, 48 and the system memory 36. The controller 34 may reside partially or entirely inside or outside of the machine 10. The control system for a handheld gaming machine 110 may be similar to the control system for the free standing gaming machine 10 except that the functionality of the respective on-board controllers may vary.

The gaming machines 10, 110 may communicate with external systems 50 (in a wired or wireless manner) such that each machine operates as a “thin client,” having relatively less functionality, a “thick client,” having relatively more functionality, or through any range of functionality therebetween (e.g., a “rich client”). As a generally “thin client,” the gaming machine may operate primarily as a display device to display the results of gaming outcomes processed externally, for example, on a server as part of the external systems 50. In this “thin client” configuration, the server executes game code and determines game outcomes (e.g., with a random number generator), while the controller 34 on board the gaming machine processes display information to be displayed on the display(s) of the machine. In an alternative “rich client” configuration, the server determines game outcomes, while the controller 34 on board the gaming machine executes game code and processes display information to be displayed on the display(s) of the machines. In yet another alternative “thick client” configuration, the controller 34 on board the gaming machine 110 executes game code, determines game outcomes, and processes display information to be displayed on the display(s) of the machine. Numerous alternative configurations are possible such that the aforementioned and other functions may be performed onboard or external to the gaming machine as may be necessary for particular applications. It should be understood that the gaming machines 10,110 may take on a wide variety of forms such as a free standing machine, a portable or handheld device primarily used for gaming, a mobile telecommunications device such as a mobile telephone or personal daily assistant (PDA), a counter top or bar top gaming machine, or other personal electronic device such as a portable television, MP3 player, entertainment device, etc.

The present concepts relate to providing wagering insurance to a player of a wagering game, or a game associated therewith. This wagering insurance is purchased by a player (e.g., via cash, credit, credits, etc.) or is otherwise bought-into or received by the player (e.g., a comp awarded to a player by a gaming establishment, a promotion by the gaming manufacturer and/or gaming establishment, a gift from another, a purchase by another, specific winning outcome(s) in a wagering game and/or bonus game, etc.) to protect against, in whole or in part, a potential risk and/or to guarantee, in whole or in part, a potential benefit, as is described herein by way of various non-limiting illustrative examples. At times, as with conventional insurance, such negative outcomes or risks are never actually realized prior to the expiration condition(s) and any asset exchanged for the wagering insurance is input to, in at least some embodiments, one or more insurance pools which accrue funds to cover payouts to other “insured” players.

The wagering insurance may be either for immediate use by the player or for application by the player at one or more later time(s), as described below. The wagering insurance is purchased, in at least some aspects, prior to play of a wagering game or prior to play of an associated game, such as a bonus game, game feature, progressive game, multi-level progressive game, group game, etcetera. Thus, in such aspects, the wagering insurance is purchased prior to the realization (e.g., reveal) of the randomly determined outcome(s) to protect against the potential for one or more negative outcome(s) and/or to guarantee one or more potential benefit(s), where the randomly determined outcome(s) is/are unknown.

In at least some other aspects, the wagering insurance may be purchased during play of a wagering game or an associated game such as, but not limited to, an individual bonus game or a multi-player bonus game. In such aspects, the wagering insurance is purchased subsequent to a partial realization (e.g., reveal) of the randomly determined outcome(s) to protect against the potential that subsequent, or subsequently realized, randomly determined outcome(s) would constitute a negative outcome and/or to guarantee that subsequent, or subsequently realized, randomly determined outcome(s) would confer a minimum potential benefit. For example, the partial reveal of the randomly determined outcome(s) could comprise, in association with a wagering game, a reveal of a majority of or substantially all of the elements of an outcome (e.g., 3 or 4 out of 5 reels having symbols revealed in a 5-reel slot game). As another example, in a bonus game wherein a player has to choose between a number of paths, the player may elect to purchase wagering insurance to ensure that, should the wrong path be selected, the player may continue to play the bonus game to accrue greater rewards.

The wagering insurance may comprise inherent constraints or limitations. For example, a player may be limited in the number of credits or the value that may be obtained utilizing wagering insurance. As another example, the number of picks that a player might be permitted in a picking game may be inherently limited. For example, in some aspects, no more than half of the bonus-terminating outcomes and/or bonus-limiting outcomes may be avoided through the purchase of wagering insurance. The inherent constraint or limitation may also include one or more predetermined expiration condition(s), wherein satisfaction of the expiration condition(s) completes the bargain and terminate(s) the wagering insurance. For example, the wagering insurance expiration condition may comprise, without limitation, one or more of a number of plays in a wagering game and/or associated game, a level of award or winnings in a wagering game and/or associated game, a duration of play in a wagering game and/or associated game, achievement of a predetermined level of a wagering game and/or associated game, a maximum predetermined loss (e.g., a loss limit) in a wagering game and/or associated game over a predetermined period of time, or the like. Other wagering insurance expiration conditions may also be utilized such as, but not limited to, a term limit (e.g, valid one year from date of purchase) or a winnings or award limit (i.e., a cap). For example, where a cap is provided, the wagering insurance is only in force for winnings or awards up to a certain amount commensurate with a purchased level of wagering insurance, at which point the insurance automatically lapses. Optionally, the player is permitted to upgrade the insurance to raise the cap. Where multiple potential caps are permitted, the player is desirably permitted the opportunity to select a desired level of insurance, including a desired cap, from a plurality of options including the various potential caps.

In at least some aspects of the present concepts, the cost of the wagering insurance is affected by the player's selections prior to wagering game play and/or during game play. Whenever effected, wagering insurance selections which confer greater potential advantages to the player bear with them a correspondingly higher cost. Any temporary alteration of the standard odds of the wagering game (or associated game) from “X” to “Y” wherein “Y” represents more favorable odds to the player and/or more favorable benefits to the player, will increase the volatility of the wagering game in a statistically predictable manner. The incremental cost associated with this temporary alteration is statistically derivable and can, therefore, be immediately passed directly to the player as the wagering insurance cost.

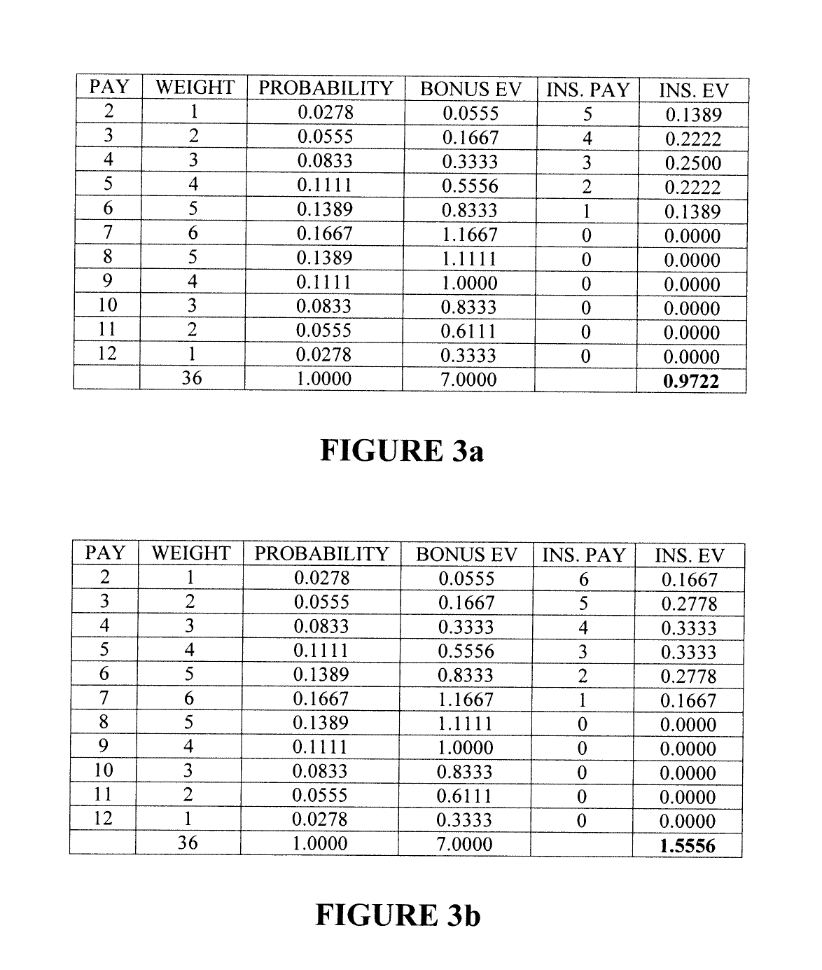

As one example, consider a bonus game wherein the player is permitted to roll two 6-sided dice and receive the total as the bonus prize. In this example bonus game, the average value of the two dice is seven and, correspondingly, the average bonus award would be seven credits. The player may be offered, in the example of FIG. 3a, wagering insurance wherein the player is assured of getting a seven or better during the bonus game. In the related example of FIG. 3b, the wagering insurance assures the player will receive a bonus award of eight or better during the bonus game. The player may opt to decline the wagering insurance or accept and pay for the wagering insurance.

FIGS. 3a-3b show tables embodying calculations representative of the above concepts. FIGS. 3a-3b show columns for “Pay” 302, “Weight” 304, “Probability” 306, “Bonus EV” 308, “Insurance Pay” 310, and “Insurance EV” 312. “Pay” 302 corresponds to a total of the two dice and “Weight” 304 corresponds to a weight of the two outcomes occurring. “Probability” 306 is the probability of an outcome occurring, which is equal to the (weight/total weight). “Bonus EV” 308 is the expected value of a given pay and is equal to the product of “pay” 302 and “probability” 306. The sum of the “probability” 306 column is the average pay of rolling the two dice. “Insurance Pay” 310 indicates how much the insurance pays for a given outcome. For example, if the player rolls a five and had purchased the wagering insurance, they will get an additional 2 credits to bring their total to the guaranteed 7 credits, as is shown in FIG. 3a. “Insurance EV” 312 is the expected value of a given insurance pay and is equal to quantity “insurance pay” 310 times “probability” 306. The sum of this “Insurance EV” 312 column is the average cost of the insurance.

As is shown in the example of FIGS. 3a-3b, wherein it is assumed that the player's wager is one credit, the wagering insurance increases the average pay of the bonus by 0.9722 and the bonus changes from an average pay of 7 credits to 7.9722 credits. To cover this change in the average pay of the bonus resulting from the provided example of wagering insurance, the gaming establishment or other controlling entity would need to charge the player an additional 0.9722 times their wager. In the example of FIG. 3b, the wagering insurance increases the average pay of the bonus by 1.5556 and the bonus changes from an average pay of 7 credits to 8.5556 credits. To cover this change in the average pay of the bonus resulting from the provided example of wagering insurance, the gaming establishment or other controlling entity would need to charge the player an additional 1.5556 times their wager. If the wager were, instead, 7 credits, then the wagering insurance cost would change to 0.1388 and 0.2222 times the wager, respectively. The cost of the wagering insurance may be rounded up or down to the next higher or lower unit of wager (e.g., cent, dime, quarter, dollar, etc.). Any excess may be retained or used, for example, to fund an insurance pool, obtain secondary insurance, etcetera.

The examples described above with respect to FIGS. 3a-3b provide, over time, a situation wherein the amount of money taken in by wagering insurance is the same as the amount paid out in extra bonus awards. In still other aspects of wagering insurance, using the above illustrative example, the player may advantageously only be charged a fraction of the wagering insurance cost. In the dice example of FIG. 3a, the player may only be charged 50% of the actual cost, which would have the effect of increasing the payout of the game. Thus, for a 92% base game with a dice bonus that hits 1 in 50 games (i.e., a bonus frequency of one bonus game in every fifty base wagering games), a 200% return on the insurance wager may end up increasing the payback percentage from 92% to 93%. Thus, where a player would expect to win on average 46 credits for every 50 credits wagered, a player purchasing wagering insurance would expect to win (46+0.9722) credits for every (50+0.9722) wagered, which yields a 92.16% game. If a player is permitted to make the above-noted insurance wager 200%, the player is only charged half of the cost of the wager, and a player purchasing wagering insurance would expect to win (46+0.9722) credits for every (50+0.4681) wagered, which yields a 93.04% game.

In various aspects, therefore, the wagering insurance cost may be determined by computation of the quantity (insured EV−standard EV) times the credits wagered. Alternatively, the wagering insurance cost may be determined by computation of the quantity (insured EV−standard EV) times the credits wagered, as above, but divided by the payback percentage. Still other variations on computation of wagering insurance cost are considered to be within the confines of the present disclosure and the methods and formulas disclosed by way of example herein are not to be considered limiting.

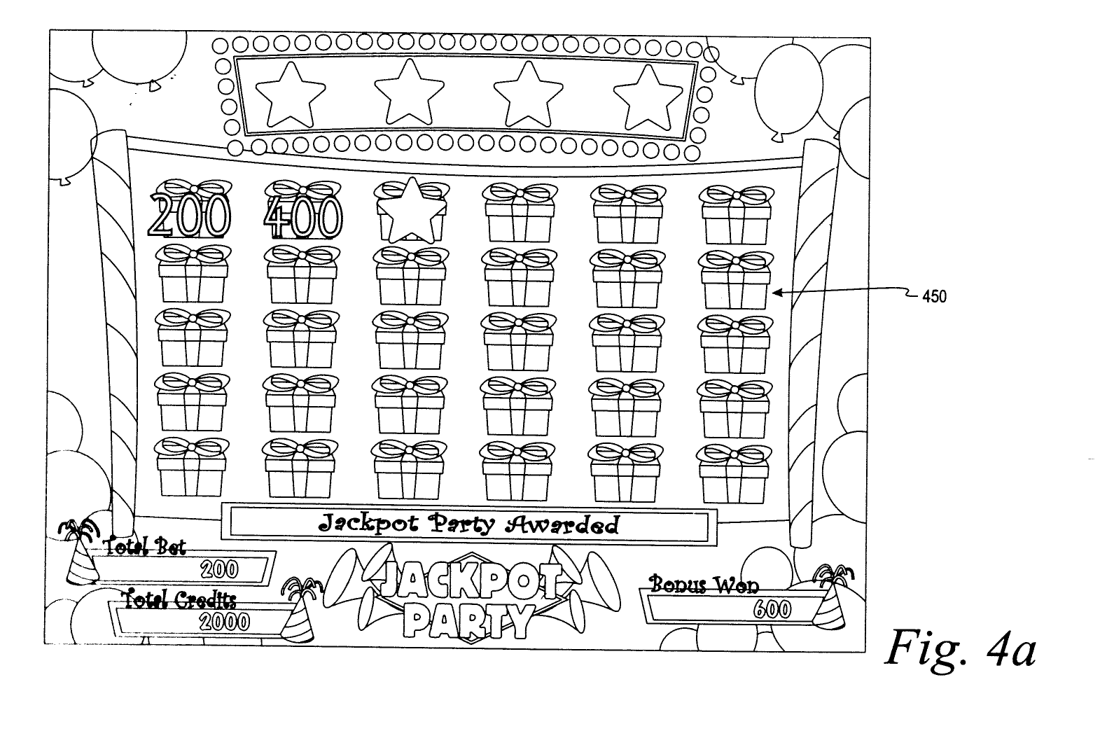

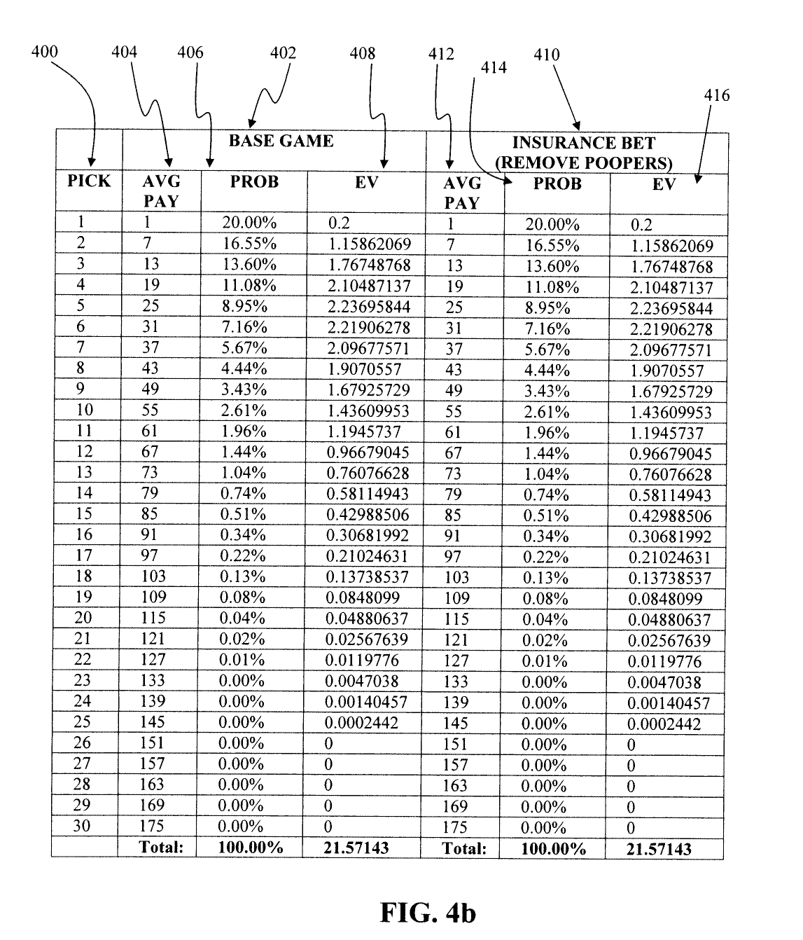

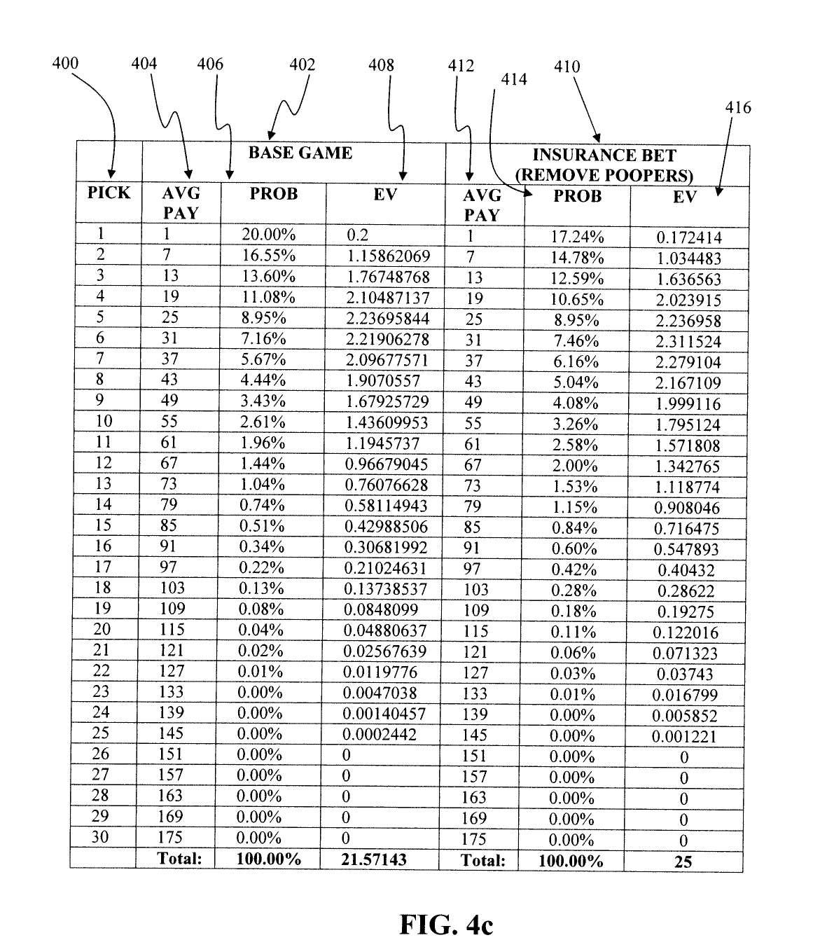

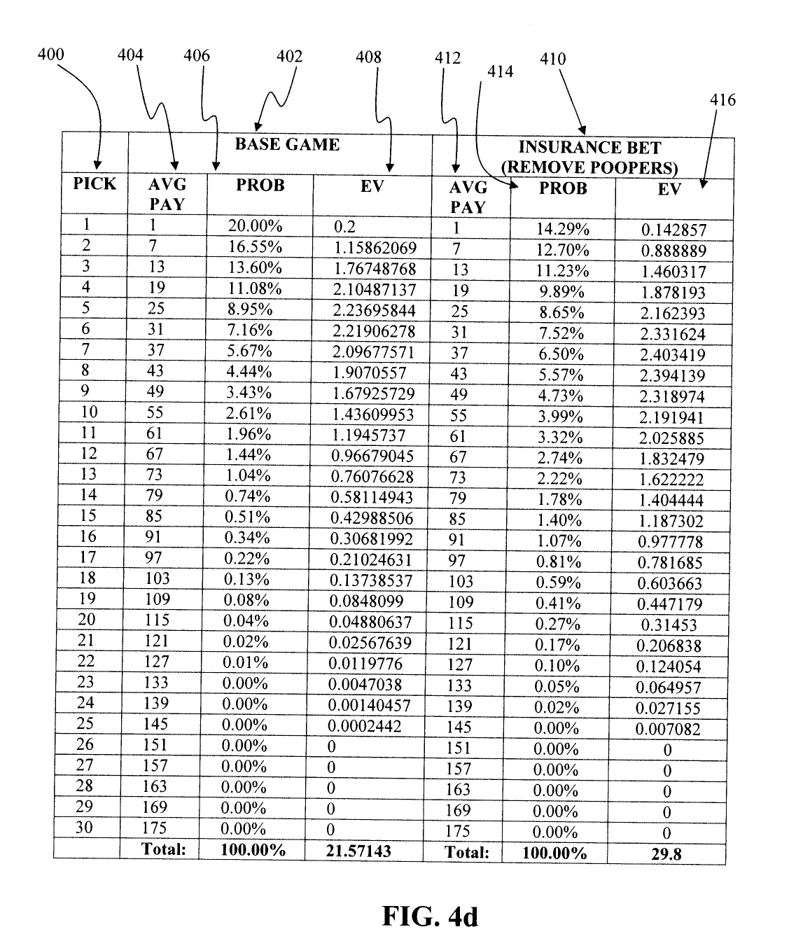

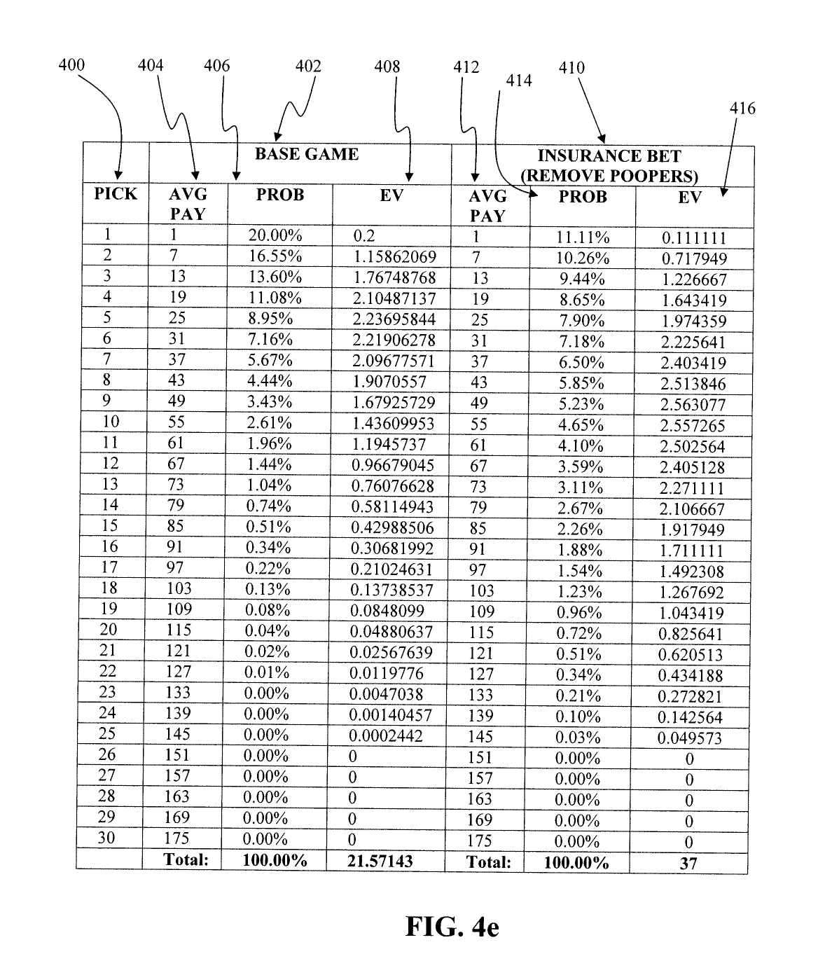

FIGS. 4a-4e show an example of wagering insurance applied to a picking-themed bonus game. FIG. 4a shows a representative display of a bonus game comprising a picking theme (e.g., a Jackpot Party-type themed game). A plurality of selectable elements (e.g., tiles, windows, graphical symbols, animations, etc.) 450 are displayed on the display 14, 16 upon initial play of the bonus game. The selectable elements 450 are optionally disposed in an array or pattern (e.g., five rows and six columns), such as is shown in FIG. 4a. Each of the selectable elements 450 is associated with a particular bonus-game outcome. The particular bonus-game outcome associated with each of the selectable elements 450 is initially concealed, as shown, so that the various outcomes associated with the selectable elements are not known to the player. The outcomes may comprise any type of outcome including, but not limited to, value-based outcomes (e.g., coin/credit values, prizes, goods, etc.) and non-value-based outcomes (e.g., “end-bonus” outcomes, “extra” picks, triggering outcomes, etc.), such outcomes being subject to predetermined constraints. For example, the numbers and types of outcomes may vary in relation to a type of bonus game or the like which is being played, the number of coins or credits played, etcetera. The distribution of the predetermined outcomes in the grid (e.g., the determination of which selectable elements are to be associated with the various outcomes) is randomly determined by the game controller. In the present example, the player is prompted to select one of the thirty selectable elements 450 using an appropriate player input device. Upon selection of a selectable element 450, the game controller causes the outcome associated with the selected selectable element to be revealed.

The selection of a selectable element 450 that is not an “end-bonus” outcome causes the controller to prompt the player to make another selection or selections, one at a time, until an end-bonus outcome is selected. Optionally, the bonus game may comprise a plurality of levels and certain of the selectable elements 450, or combinations thereof, may be associated with an outcome advancing bonus game play to another level.

FIGS. 4b-4e show, for “Picks” 400 ranging from 1-30. A “Base Game” 402 section is shown to comprise columns for “Average Pay” 404, “Base Game Prob” 406, and “Base Game EV” 408. Each of FIGS. 4b-4e also show an “Insurance Bet (Remove Poopers)” 410 section comprising columns for “Average Pay” 412, “Prob” 414, and “EV” 416 for the bonus game. The “Average Pay” column 412 and “Prob” column 414 respectively represent the average pay and probability for a player ending his or her bonus round on the enumerated pick. In the example of FIG. 4b, which corresponds to the example shown in FIG. 4a, a baseline configuration comprising a random distribution of 24 bonus-award outcomes and six bonus-ending outcomes (e.g., “poopers”) is provided. The player selects the player-selectable elements until a bonus-ending outcome is revealed. In the example of FIG. 4b, the player, at most, can select 24 bonus-award outcomes with a 25^{th} selection necessarily being a bonus-ending outcome.

In the example of FIGS. 4b-4e, the player is permitted to select the number of bonus-ending outcomes (“poopers”) that may be removed by the player upon purchase of wagering insurance. In the present example, removed poopers are eliminated from the field of available selectable elements. Thus, in the present example, if a player removes two poopers, only twenty-eight selectable elements will remain. In other aspects, the removed poopers could optionally be replaced by an award or other positive outcome.

The cost to the player for the wagering insurance increases as greater numbers of the bonus-ending outcomes are removed by the player. The probability in the “Prob” 414 column represented is the probability that a player will select a bonus-ending outcome which will end the bonus round on that pick. It is assumed, for the example of FIGS. 4b-4e, that the average bonus-ending outcome consolation prize payout is one extra credit and the average pick payout is six credits. These values are arbitrary values, but provide a useful baseline for illustrative purposes in determining, for example, the “Average Pay” column 412 and “EV” 416 for the bonus round. As noted above, the “Average Pay” column 412 and “Prob” column 414 respectively represent the average pay and probability for a player ending his or her bonus round on the enumerated pick. FIG. 4b shows that if a player ends his or her bonus on the first pick, then the player could only have picked a pooper, which pays one credit under the illustrated example. Likewise, if a player ends his or her bonus on the nth pick, that means that the player made n−1 successful award picks and one pooper pick. Under the present example, if the player ends on the fourth pick, the player will win 19 credits (e.g., 6*(4−1)+1*1).

FIG. 4c shows the effect of removing one of the six bonus-ending outcomes by the player. The difference between the “Insurance Bet EV” column 416 and the “Base Game EV” column 408 is the cost for wagering insurance that would provide a 100% return for the wager difference in expected value (EV) between the initial configuration of the bonus round (e.g., n bonus-ending selectable elements) and the modified configuration of the bonus round (e.g., n−x bonus-ending selectable elements, where x is an integer smaller than n). Stated differently, in this example, the cost of the wagering insurance is the same as the change in the expected value.

Players, as a group, will correspondingly get back 100% (or a lesser portion) of the cost of the wagering insurance, on average. However, on an individual basis, a player may not receive a bonus award that would return 100% of that individual player's wagering insurance cost (e.g., the player picked a selectable element or series of selectable elements that would not have invoked the protection of the wagering insurance), whereas another player may receive a direct benefit from the wagering insurance and may receive a bonus award that is larger than the player would have otherwise received without the benefit of the wagering insurance and larger than the added cost of the wagering insurance. Thus, in this respect, wagering insurance may operate similarly to, for example, automobile insurance, wherein some drivers who never have a claim “lose” the cost of their premiums and other drives submit one or more claims that exceed the value of the premiums paid, resulting in a net benefit to the driver.

In FIG. 4c, this difference in expected value between the “Insurance Bet EV” column 416 and the “Base Game EV” column 408 amounts to about 3.43 (i.e., 25−21.57143). In FIG. 4d, this difference amounts to about 8.23 (i.e., 29.8−21.57143). In FIG. 4e, this difference amounts to about 15.43 (i.e., 37−21.57143). These differences in expected value, however manifested, are passed on to the player(s) in at least some aspects of the present concepts. Thus, in a situation, such as in the baseline example of FIGS. 4b, where the average bonus return is 21.57 times the player's bet (e.g., 1 credit, 5 credits, 900 credits, etc.), the removal of one bonus-ending selectable element will increase the average bonus return to 25 times the player's bet. Thus, in configurations where the bonus amount is multiplied by the total wager, the amount that the player is charged for wagering insurance, the difference in the expected value, needs to be multiplied by the total wager. However, not all bonuses are multiplied by the total wager. Some are, for example, multiplied by the line bet only. However, in these cases the initial odds of triggering the bonus generally take into account the total amount of the wager. For example, a bonus game may pay a fixed amount, such as 400 credits, no matter what total amount is wagered, but the odds of triggering the bonus are 1/N at a 1 line bet and x/N at an x line bet. So the wagering insurance cost is scaled by the base game total wager based on how the bonus is triggered.

As noted above, the cost of the wagering insurance may be rounded up or down to the next higher or lower unit of wager (e.g., cent, dime, quarter, dollar, etc.) and, if desired, any excess may be retained or used, for example, to fund an insurance pool, obtain secondary insurance, or the like.

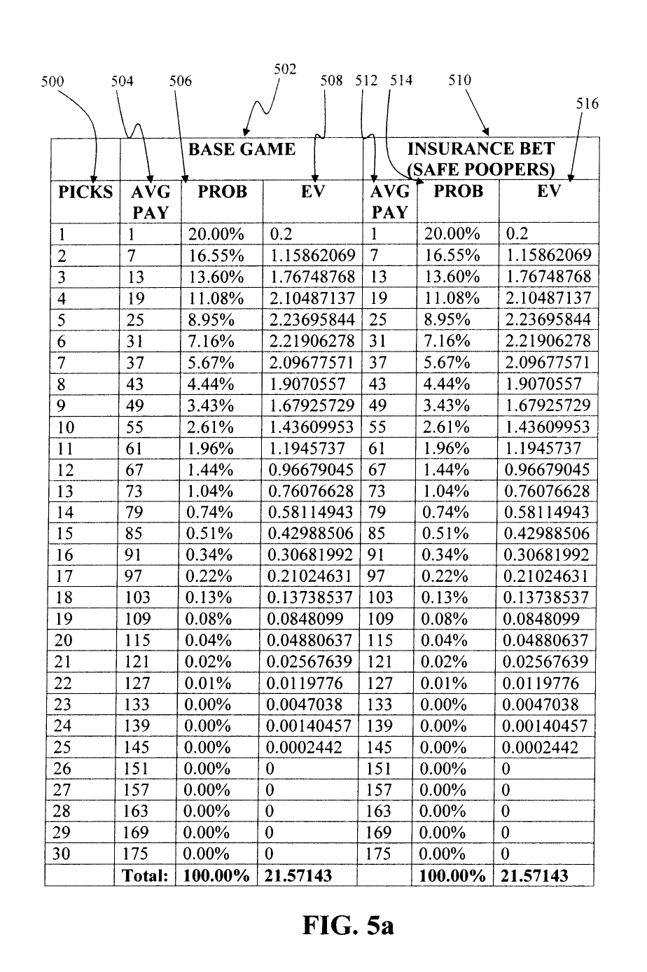

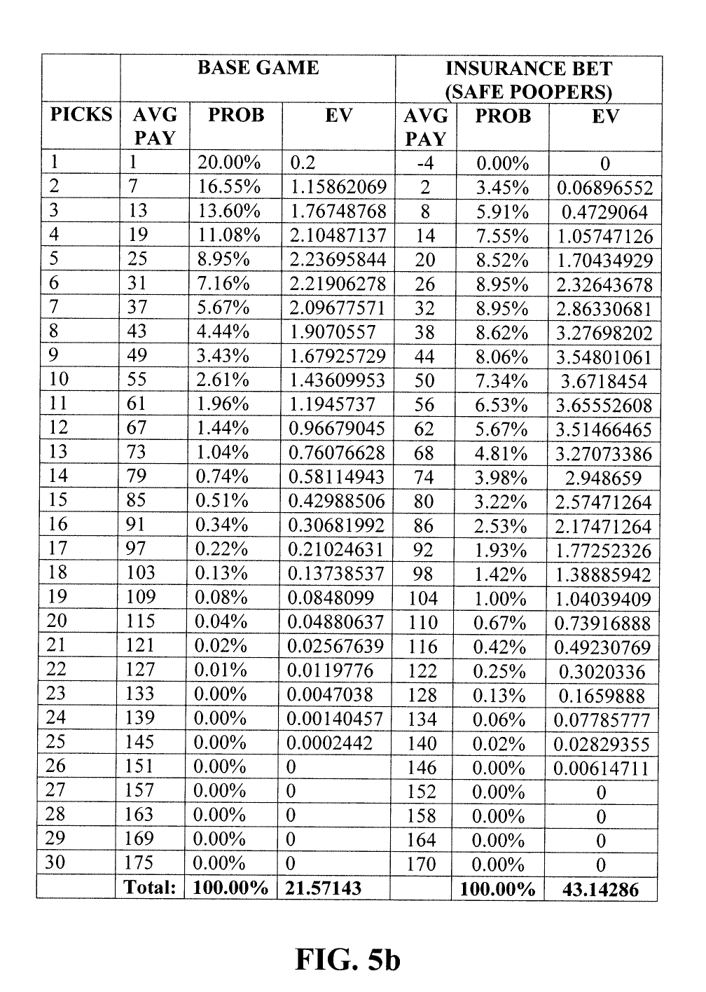

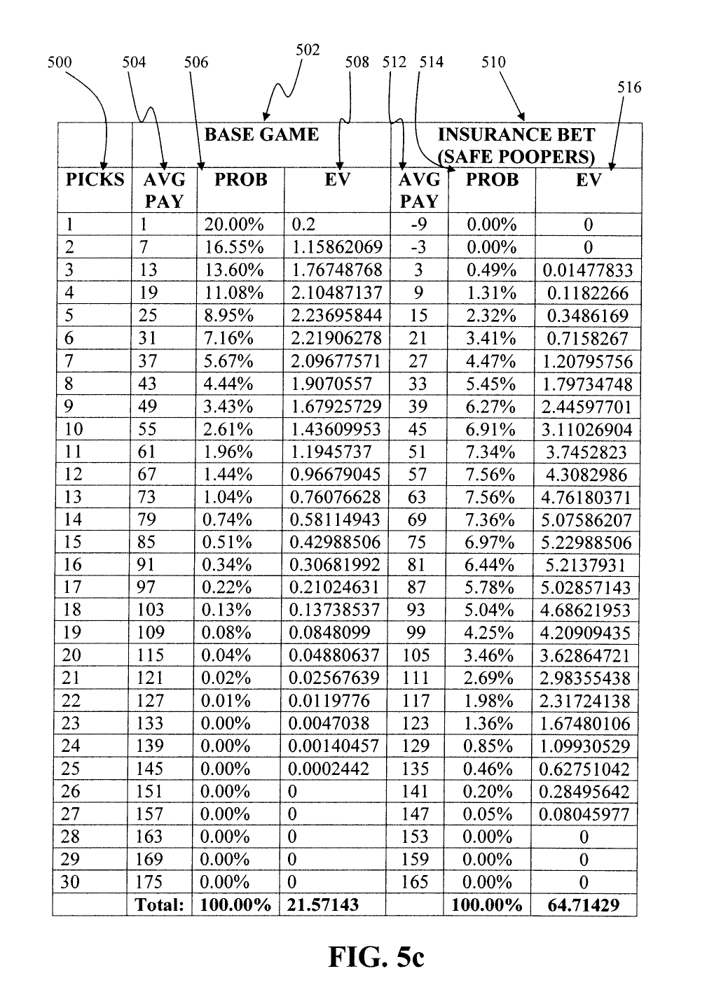

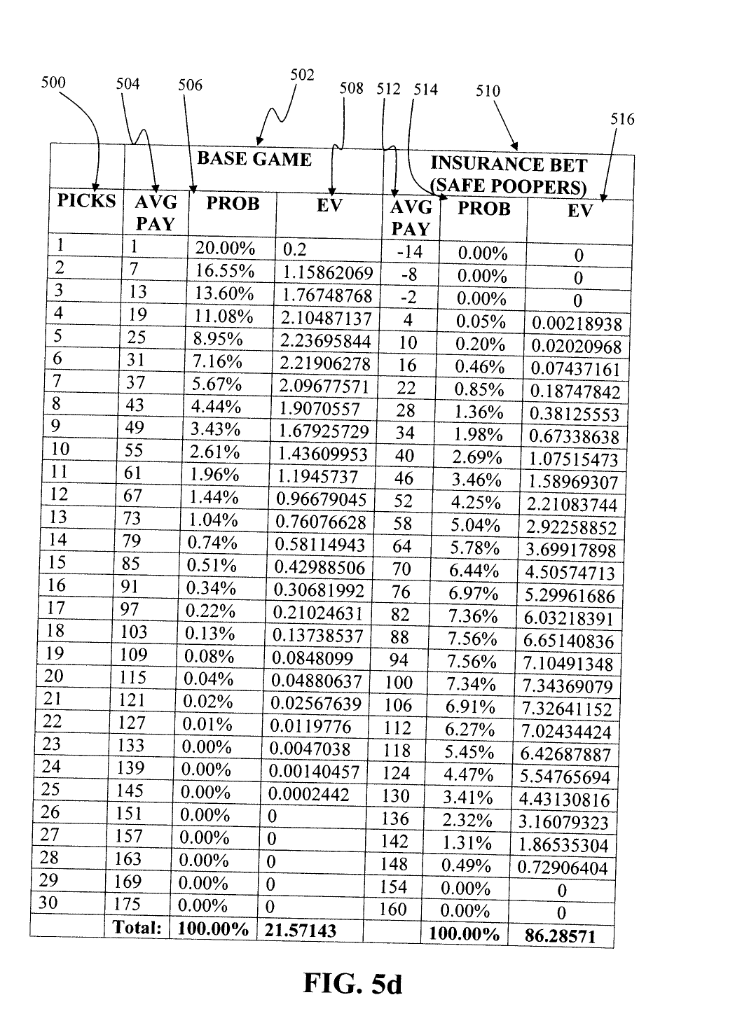

FIGS. 5a-5d show another example of wagering insurance applied to a Jackpot Party-type picking bonus game. FIGS. 5a-5d show, for “Picks” column 500 ranging from 1-30, a “Base Game” 502 section comprising columns for “Average Pay” 504, “Base Game Prob” 506, and “Base Game EV” 508. Each of FIGS. 5a-5d also show an “Insurance Bet (Safe Poopers)” 510 section comprising columns for “Average Pay” 512, “Prob” 514, and “EV” 516.

FIG. 5a represents a baseline configuration wherein there are 24 bonus award outcomes and six bonus-ending outcomes (e.g., “poopers”), randomly distributed amongst 30 player selectable elements (e.g., presents). The player selects from any of the 30 available player-selectable elements until a bonus-ending outcome is revealed. In the example of FIGS. 5a, the player, at most, can select 24 bonus award outcomes with a 25^{th} selection necessarily being a bonus-ending outcome.

In the example of FIGS. 5a-5d, the player is permitted to select the number of player selections that are guaranteed to be safe. Thus, rather than removing the bonus-ending outcomes from the bonus game, as with the example of FIGS. 4a-4d, the bonus-ending outcomes are merely held in abeyance until after a predetermined number of “safe” selections, defined by the purchase of varying levels of wagering insurance, have been made. The cost to the player for the wagering insurance increases as greater numbers of safe selections are guaranteed to the player. Thus, the cost of wagering insurance to guarantee that the first three selections of player-selectable elements in the bound round are not bonus-ending outcomes is higher than the cost of wagering insurance to guarantee that the first two selections of player-selectable elements in the bonus round are not bonus-ending outcomes.

The probability in the “Prob” column 514 represented is the probability that a player will select a bonus-ending outcome which will end the bonus round on that pick. It is assumed, for the example of FIGS. 5a-5d, that the average bonus-ending outcome consolation prize payout is one extra credit and the average pick payout is six credits. These values are arbitrary values, but provide a useful baseline for illustrative purposes in determining, for example, the “Average Pay” column 512 and “EV” column 516 for the bonus round.

FIG. 5b shows the effect of ensuring, via the purchase of wagering insurance, that the player's first selection in the bonus round is not a bonus-ending outcome. removing one of the six bonus-ending outcomes by the player. The difference between the “Insurance Bet EV” column 516 and the “Base Game EV” column 508 is the cost for wagering insurance that would provide a 100% return for the wager difference in expected value (EV) between the initial configuration of the bonus round and the modified configuration of the bonus round. Stated differently, in this example, the cost of the wagering insurance is the same as the change in the expected value.

Players, as a group, will correspondingly get back 100% of the cost of the wagering insurance, on average. However, as noted above, on an individual basis, a player may not receive a bonus award that would return 100% of that individual player's wagering insurance cost (e.g., the player picked a selectable element or series of selectable elements that would not have invoked the protection of the wagering insurance), whereas another player may receive a direct benefit from the wagering insurance and may receive, through intervention of the wagering insurance, a bonus award larger than the player would have otherwise received without the benefit of the wagering insurance and larger than the added cost of the wagering insurance.

In FIG. 5b, this difference in expected value between the “Insurance Bet EV” column 516 and the “Base Game EV” column 508 amounts to about 21.57 (i.e., 43.14286−21.57143). In FIG. 5c, this difference amounts to about 43.1428571 (i.e., 64.71429−21.57143). In FIG. 5d, this difference amounts to about 64.7142857 (i.e., 86.28571429−21.57143). These differences in expected value, however manifested, are passed on to the player(s) in at least some aspects of the present concepts.

In accord with the example of FIGS. 5a-5d, it is impossible to end a bonus game on the first round if a single bonus-ending outcome is deferred. To the contrary, in the example of FIGS. 4a-4e, it is still possible to end a bonus game on the first round even though one or more bonus-ending outcomes has/have been removed. Thus, the difference between these two embodiments may be readily observed if the “Prob” column 514 is compared to the “Prob” column 414 for corresponding numbers of removed/deferred bonus-ending outcomes. For example, if a player removes one bonus-ending outcome, the player has a 17% of ending the bonus on the very first pick, whereas if a player defers one bonus-ending outcome, the player has a 0% chance of ending the bonus on the very first pick. Overall, as between these two examples, the numbers reflect that a player is likely to receive more picks when the bonus-ending outcome is deferred rather than removed.

As noted above, the cost of the wagering insurance may be rounded up or down to the next higher or lower unit of wager (e.g., cent, dime, quarter, dollar, etc.) and, if desired, any excess may be retained or used, for example, to fund an insurance pool, obtain secondary insurance, or the like.

In still other aspects of the present concepts, the wagering insurance might apply not to a single player selection of a selectable element (e.g., 450; FIG. 4a), but rather to an entire bonus round. Thus, one aspect of wagering insurance in accord with the present concepts permits a player to purchase and apply wagering insurance to guarantee a certain predetermined outcome in a basic wagering game, bonus game, progressive game, group game, game feature, or the like, or combinations and/or blocks thereof, and/or eligibility for any of the preceding. As noted above, the predetermined outcome is an arbitrary amount (e.g., 200 credits, 500 credits, 1000 credits, etc.) selected by a player based on a player's balancing of the desired risks, benefits, and the cost of the wagering insurance, which varies in relation to the player's change in the wagering games' expected value. If, after having applied the wagering insurance, the revealed outcome is less than the threshold outcome, the outcome is automatically discarded (or the player is provided the option to discard), and a new outcome determined. This process continues until the outcome has met or exceeded the predetermined threshold outcome. Thus, a player is permitted to purchase wagering insurance to provide that player with the option to “throw back” a win if it isn't good enough.

Players may purchase wagering insurance to prevent realization of, or to hold in abeyance, one or more defined outcomes or risks in a wagering game and/or an associated game. Conversely, players may purchase wagering insurance to receive a predetermined benefit during a wagering game and/or an associated game (e.g., a predetermined minimum number of “safe” picks in a picking game). Thus, the wagering insurance may be generally implemented to avoid or delay undesirable outcomes, at least until expiration of any predetermined condition(s) (e.g., time, number of picks, cumulative value of awards, etc.) or to ensure or improve the odds of desirable outcomes, such as by removing or deferring undesirable outcomes that would foreclose realization of a desired predetermined benefit or award.

In at least some aspects of some embodiments of the present concepts, the wagering insurance must be purchased or obtained by the player prior to play of a basic wagering game. For example, a player may pre-pay for a single unit of wagering insurance, such as may correspond to a fixed wager amount commonly used by the player, having one or more pre-defined conditions (e.g., expiration condition) and one or more benefits (e.g., two guaranteed “safe” picks during any bonus round in which wagering insurance is to be applied). As another example, a player may pre-purchase plural units (e.g., a block of) wagering insurance wherein the plural units (e.g, 10, 20, 50, 100, 200, 500, 1000) are divisible into discrete units (e.g., 1 credit, 5 credits, 10 credits, 25 cents, 1 dollar, 5 dollars, etc.) that may be separately and/or collectively applied.

Any desired manual or automatic mechanism may be used to trigger the wagering insurance, prompt a player for application or redemption of the wagering insurance, or otherwise put the wagering insurance into play. Thus, for example, the wagering insurance may be automatically applied, in accord with any pre-defined conditions or triggers, to draw down a number of units of the wagering insurance proportional to a player's wager. For example, the player may selectively engage the wagering insurance, placing the wagering insurance into play into a background that is automatically engaged (e.g., irrevocably redeemed) upon the occurrence of a predetermined event. In another example, the player may selectively engage the wagering insurance upon the occurrence of a predetermined event, such as entry into a bonus game. In still another example, the player may selectively engage the wagering insurance during a predetermined event, such as during a bonus game.

In at least some aspects of some embodiments of the present concepts, the wagering insurance may be purchased or obtained by the player subsequent to play of a basic wagering game, but prior to play of a game or feature (e.g., a bonus game) in which the wagering insurance is to be applied or redeemed.

In still other aspects of at least some embodiments of the present concepts, the wagering insurance may be purchased or obtained by the player subsequent to initiation of play of the game or feature (e.g., a bonus game) in which the wagering insurance is to be applied or redeemed. For example, a player playing a picking bonus game, such as the example described above, may decide after several successful selections of player-selectable elements that he or she does, in fact, want to utilize the wagering insurance to remove a bonus-ending or a bonus limiting outcome, to defer a bonus-ending or a bonus limiting outcome, to prevent the occurrence of a bonus-ending or a bonus limiting outcome, to guarantee some other type of beneficial outcome to the player, or the like. The player may then elect to put into play or redeem his or her wagering insurance, in an amount related to (e.g., less than, greater than, or equal to) the difference in the expected outcome arising from the player's requested modification to the game or feature. Once the election has been made, play in the game or feature may continue, under the benefit of the wagering insurance, until the expiration condition(s) of the wagering insurance are satisfied. Consistent with this concept, a player may incrementally purchase insurance as a game is being played. With respect the picking game example illustrated in FIG. 4a, for example, a player would be permitted to purchase and/or enable wagering insurance at any time to guarantee/prevent and selected outcome, with the change in the expected value caused by the action (if any) of such wagering insurance, or an amount related thereto, passed onto to the player.

In another aspect of the present concepts, wagering insurance could be provided on a total amount of money wagered to guarantee a certain threshold outcome. For example, wagering insurance could be purchased to guarantee that, for twenty dollars played by a player on a wagering game machine 10, 110, the player will get his or her twenty dollars back if he or she doesn't hit a bonus. In another example, wagering insurance could be purchased to guarantee that, for twenty dollars played by a player on a wagering game machine 10, 110, the player will be receive a certain minimum number of spins.

A player may even be permitted to purchase wagering insurance, apply a pre-purchased wagering insurance, or apply a pre-earned wagering insurance in advance of a reveal to the player of a randomly determined outcome and/or randomly determined outcomes corresponding to a selected player-selectable element. For example, after a player selects a player-selectable element, but prior to the reveal, a pop-up window, icon, avatar, text message, or other type of communication may be used to query a player as to the player's desire to proceed without the benefit of wagering insurance or to purchase and/or apply a pre-purchased/pre-earned wagering insurance. If the player answers in the negative, the selected player-selectable element then reveals the randomly determined outcome. If the player answers in the positive, the player is prompted to purchase or apply the wagering insurance, at which point the selected player-selectable element reveals the randomly determined outcome, or other outcome as may have been invoked by the wagering insurance.

In accord with the present concepts, where the wagering insurance acts to alter any randomly determined outcome (e.g., by deferring a bonus-ending outcome), the controller may advantageously apprise the player of the intervention of the wagering insurance and/or the avoided or deferred negative outcome so as to inform the player of the player's judicious application of the wagering insurance.

In at least some aspects of the present concepts, the wagering insurance is required to be used in a single gaming session. In at least some other aspects of the present concepts, the wagering insurance is permitted to be used by the player in any number of gaming sessions, on one or more gaming machines 10, 110, subject to a pre-defined expiration condition for the wagering insurance. Such gaming machines 10, 110 are, in accord with various aspects and without limitation, a pre-defined gaming machine(s) (e.g., a gaming machine at which the wagering insurance is obtained or a bank of gaming machines associated with the obtaining of the wagering insurance), gaming machines of the same theme (i.e., the same type of game), different gaming machines of the same family (e.g., differently themed wagering games utilizing the same underlying math/algorithms), gaming machines on the floor of a particular gaming establishment, or gaming machines on the floor of a particular gaming establishment and any related gaming establishments (e.g., sister casinos). Thus, non-temporal limitations are optionally imposed on the wagering insurance in accord with at least some aspects of the present concepts.

The present concepts are not limited to any particular wagering game (or game associated therewith). Moreover, although the present concepts are described herein in relation to an example of a free-standing gaming machine 10 or a handheld or mobile gaming machine 110, the present concepts are extendable to encompass table-based games or other wagering games, which may comprise, but are not limited to, table-based games or other wagering games implemented on machines or gaming systems other than the aforementioned gaming machines 10, 110 (e.g., on-line wagering games), such machines or gaming systems being stand-alone, networked, local or remote.

Accordingly, the disclosed wagering insurance permits a player to exchange one or more assets (e.g., cash, credit, credits, etc.) for a predetermined benefit and such predetermined benefit will accrue to the player, despite any occurrence of a randomly determined outcome and/or randomly determined outcomes that would, but for the wager insurance, foreclose realization of such desired predetermined benefit.

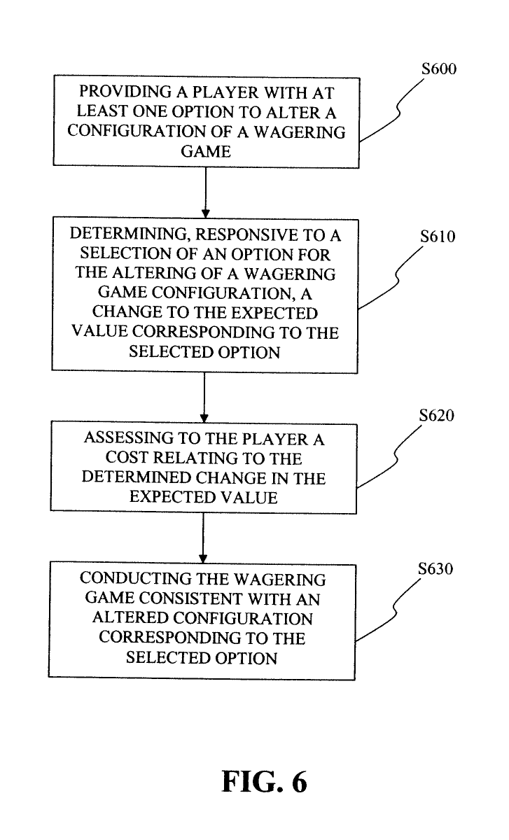

FIG. 6 shows acts associated with one method of playing a wagering game in accord with some aspects of one embodiment of the present concepts. Further to the above disclosure, this method includes an act S600 of providing a player with at least one option to alter a configuration of a wagering game and an act S610 of determining, responsive to a selection of an option for the altering of a wagering game configuration, a change to the expected value corresponding to the selected option. The method includes the additional acts of assessing to the player a cost relating to the determined change in the expected value (S620) and conducting the wagering game consistent with an altered configuration corresponding to the selected option (S630). Optionally, if the player elects not to immediately invoke the benefit of the altered configuration of the wagering game, the player may elect to have the gaming machine perform the act of issuing wagering insurance to the player subsequent to said act of assessing to the player a cost relating to the determined change in the expected value. The player may then utilize the issued wagering insurance at a later time to effect the desired alteration. Thus, the conducting of the wagering game consistent with an altered configuration corresponding to the selected option may occurs substantially contemporaneous with the act S620 of assessing to the player a cost relating to the determined change in the expected value or the conducting of the wagering game consistent with an altered configuration corresponding to the selected option may occur at any time subsequently selected by a player. As noted above, the option to alter a configuration of a wagering game may comprises an option to alter a configuration of wagering games including, but not limited to, a base wagering game, a bonus game, a progressive game, and/or a group game.

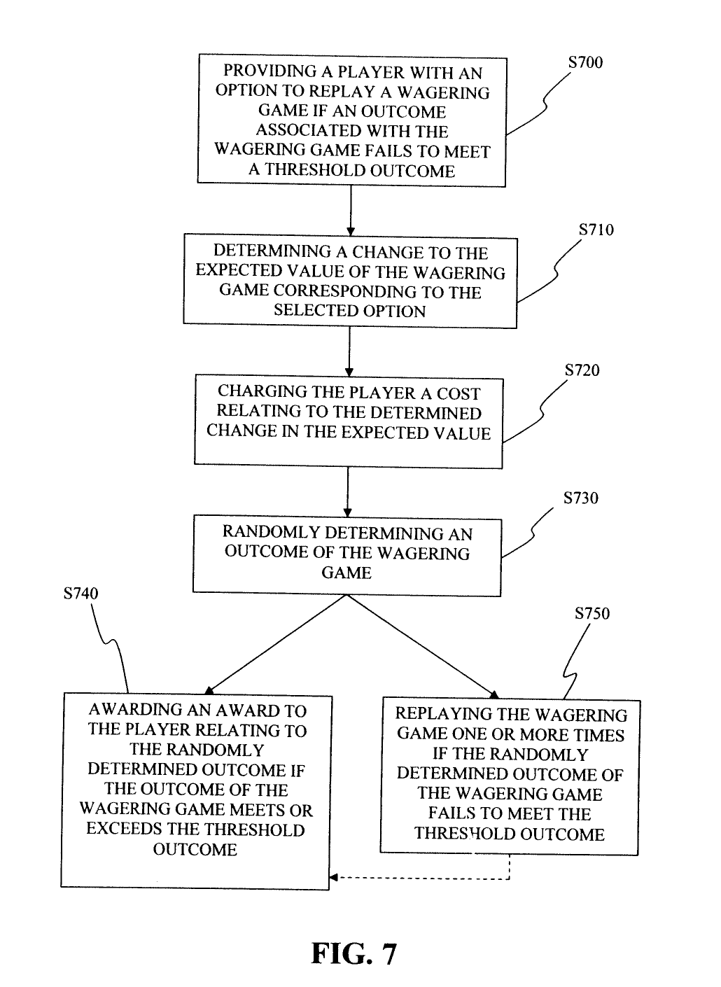

FIG. 7 shows acts associated with another method of conducting a wagering game in accord with yet other aspects of the present concepts. The method represented by FIG. 7 includes the act S700 of providing a player with an option to replay a wagering game if an outcome associated with the wagering game fails to meet a threshold outcome and the act S710 of determining a change to the expected value of the wagering game corresponding to the selected option. The method further includes the acts of charging the player a cost relating to the determined change in the expected value (S720) and randomly determining an outcome of the wagering game (S730). This method may further include, for example, the act S740 of awarding an award to the player relating to the randomly determined outcome if the outcome of the wagering game meets or exceeds the threshold outcome or, alternatively, if the randomly determined outcome of the wagering game fails to meet the threshold outcome, the act S750 of replaying the wagering game one or more times (e.g., until the outcome of the wagering game meets or exceeds the threshold outcome).

In at least some aspects of the disclosed concepts, should the randomly determined outcome of the wagering game fail to meet the threshold outcome, the method optionally comprises returning at least a portion of the cost charged to the player. Thus, for example, if a player purchases wagering insurance to ensure that, for a $100 input value, the player is guaranteed to play at least one bonus round, the player will receive back his or her $100, or a predetermined portion thereof (e.g., $80, $20), if the wagering game play corresponding to the input $100 fails to yield a bonus round.

As previously noted, the wagering insurance concepts disclosed herein may be used in various wagering contexts including, but note limited to, wagering insurance may be used to guarantee that a bonus will be triggered within a predetermined number or credit value of spins, a predetermined minimum number of picks in a picking game, a number of free spins that will be earned, a threshold credit value that will be earned (e.g., the game will be replayed until at least the threshold credit value is met), a predetermined minimum number of plays in a wagering game and/or associated game, a predetermined minimum level of award or winnings in a wagering game and/or associated game, a predetermined minimum duration of play in a wagering game and/or associated game, achievement of a predetermined minimum level of a wagering game and/or associated game, a maximum predetermined loss (e.g., a loss limit) in a wagering game and/or associated game over a predetermined period of time, or any combination thereof.

Each of these embodiments, combinations of embodiments, combinations of aspects of various different embodiments, and obvious variations thereof are contemplated as falling within the spirit and scope of the claimed invention, which is set forth in the following claims. For example, the player may optionally be associated with one of a plurality of wagering insurance categories in accord with a player's historical data, particularly that historical data associated with that player's use of insurance. Each of the plurality of insurance categories may, for example, reflect various ranges of winnings, success rates, and/or characteristics of insurance use (e.g., games, situations, etc.). The rates for wagering insurance available to the player may optionally be adjusted, upwardly or downwardly, based on the player's assigned category of wagering insurance. As another example, in accord with the present concepts, the selection of the aforementioned player-selectable elements, such as described in relation with FIG. 4a, may be performed by a player or by a controller 34.

The present disclosure uses the terms “wager insurance” or “wagering insurance” to describe general concepts of a bargain between the player and the gaming establishment to describe a mechanism by which a player may exchange an asset to generally defer, in some fashion, realization one or more defined “negative” outcomes in a wagering game and/or an associated game or, alternatively to guarantee, in some fashion, realization of one or more defined “positive” outcomes. The actual bargain between the player and the gaming establishment need not be considered technically as insurance, nor does it require the actual “issuance” of a record (e.g., electronic record, physical record, etc.) memorializing the bargain, although such record would certainly be advantageous.

Although the present disclosure refers generically to “wager insurance” or “wagering insurance” the term “insurance” is not intended to be construed strictly. Instead, as generally defined herein, the terms wager insurance or wagering insurance, or like terms (e.g., bargain, fee, exchange, pooper remover, etc.), describe any mechanism, manner, or way in which a player may exchange an asset to foreclose or prevent realization of one or more defined outcomes or risks in a wagering game and/or an associated game, whether or not such defined risk is actually realized during play. For example, a player may obtain wagering insurance so that one or more randomly determined game-ending outcomes (or game-limiting outcomes), if realized, will discarded by the game controller in favor of other randomly determined or outcomes (e.g., a player-selected selectable element concealing a randomly determined outcome) or so that one or more randomly determined award-limiting outcomes, if realized, are discarded by the game controller in favor of such other randomly determined outcomes.

The terms “wager insurance” or “wagering insurance,” or like terms, further describe any mechanism, manner, or way in which a player may exchange an asset to hold in abeyance a defined risk in a wagering game and/or an associated game, whether or not such defined risk is actually realized during play. For example, a player may obtain wagering insurance so that a game-ending outcome (or game-limiting outcome) is deferred to permit completion of the pre-defined benefit such as, but not limited to, a minimum number of picks, a minimum duration of play, etcetera. Following satisfaction of the pre-defined benefit, the deferred game-ending outcome (or game-limiting outcome) may be, in various aspects, immediately reinstated, in the case of deferred game-ending outcome, to immediately end the game or randomly distributed amongst the remaining selectable-elements or population of available bonus elements, however configured, for a subsequent random selection by the player or by the controller.

Also expressly included within the spirit and scope of the claimed invention are any permutation or combination of the dependent claims set forth herein with a respective one of the independent claims, irrespective of the presently claimed dependency. As used herein, the term wagering game, where used in association with the wagering insurance disclosed herein, shall be interpreted to comprise the wagering game and/or any associated game(s) or activities.

What is claimed is:

1. A gaming system for playing a wagering game, comprising:
a value input device adapted to receive an input value corresponding to a wager to enable the play of a wagering game;
a display configured to display a randomly determined outcome; and
a controller operative to accept a redemption of wagering insurance in association with said randomly determined outcome prior to a reveal of said randomly determined outcome and operative to alter at least one aspect of the wagering game consistent with a condition defined by said wagering insurance.

2. A gaming system for playing a wagering game, according to claim 1, wherein the randomly determined outcome is associated with a basic wagering game.

3. A gaming system for playing a wagering game, according to claim 2, wherein the controller is configured to issue said wagering insurance for a predetermined cost relating to a change in an expected value of the wagering game from a base configuration arising from said altering of at least one aspect of the wagering game.

4. A gaming system for playing a wagering game, according to claim 1, wherein the randomly determined outcome is associated with at least one of a bonus game, a progressive game, or a group game.

5. A gaming system for playing a wagering game, according to claim 4, wherein the controller is configured to issue said wagering insurance for a predetermined cost relating to a change in an expected value of the wagering game from a base configuration arising from said altering of at least one aspect of the wagering game.

6. A gaming system for playing a wagering game, according to claim 1, wherein the controller is operative to, alter the probability of a reveal of a specified randomly determined outcome in response to an association of said wagering insurance to said randomly determined outcome.

7. A gaming system for playing a wagering game, according to claim 1, wherein the controller is operative to alter the consequence of a reveal of a specified randomly determined outcome in response to an association of said wagering insurance to said randomly determined outcome.

8. A gaming system for playing a wagering game, according to claim 1, wherein the controller is operative to reveal a randomly determined outcome that is consistent with an acceptable category of outcomes and to discard a randomly determined outcome that is consistent with a prohibited category of outcomes, the controller being operative to reveal and discard in response to an association of said wagering insurance to said randomly determined outcome,.

9. A method of conducting a wagering game, the method comprising:
providing a player with at least one option to alter a configuration of a wagering game;
determining, responsive to a selection of the at least one option for the altering of the wagering game configuration, a change to the expected value corresponding to the selected option;
assessing a cost relating to the determined change in the expected value; and
conducting the wagering game consistent with an altered configuration corresponding to the selected option.

10. A method of conducting a wagering game according to claim 9, the method further comprising:
issuing wagering insurance to the player subsequent to said act of assessing the cost relating to the determined change in the expected value.

11. A method of conducting a wagering game according to claim 9, wherein said conducting of the wagering game consistent with an altered configuration corresponding to the selected option occurs substantially contemporaneous with said act of assessing to the player a cost relating to the determined change in the expected value.

12. A method of conducting a wagering game according to claim 9, wherein said conducting of the wagering game consistent with an altered configuration corresponding to the selected option occurs at any time subsequently selected by a player.

13. A method of conducting a wagering game according to claim 9, wherein said at least one option to alter a configuration of a wagering game comprises an option to alter a configuration of a base wagering game.

14. A method of conducting a wagering game according to claim 9, wherein said at least one option to alter a configuration of a wagering game comprises an option to alter a configuration of at least one of a bonus game, a progressive game, or a group game.

15. A computer readable storage medium encoded with instructions for directing a gaming system to perform the method of claim 9.

16. A method of conducting a wagering game on a gaming machine, the method comprising:
prompting a player to redeem at least one unit of wagering insurance;
altering, responsive to said redeeming of at least one unit of wagering insurance, a configuration of a wagering game on the gaming machine from a first configuration to a second configuration in accord with one or more conditions associated with the redeemed wagering insurance;
conducting the wagering game consistent with the altered configuration;
satisfying an expiration condition for the redeemed wagering insurance; and
returning the configuration of the wagering game on the gaming machine from the second configuration to the first configuration responsive to the satisfying of the expiration condition for the redeemed wagering insurance.

17. A method of conducting a wagering game according to claim 16, wherein the wagering game comprises at least one of an alteration of a bonus game, bonus game, a progressive game or a group game.

18. A method of conducting a wagering game according to claim 16, wherein a condition associated with the wagering insurance comprises a predetermined number of bonus-ending outcomes that are to be removed from the population of selectable elements.

19. A method of conducting a wagering game according to claim 16, wherein a condition associated with the wagering insurance comprises a predetermined number of selections from a population of selectable elements for which a bonus-ending outcome will be deferred.

20. A method of conducting a wagering game according to claim 16, wherein a condition associated with the wagering insurance comprises a predetermined number of selections from a population of selectable elements for which a bonus-ending outcome will be discarded in favor of a randomly determined non-bonus-ending outcome.

21. A method of conducting a wagering game, the method comprising:
providing a player with an option to replay a wagering game if an outcome associated with said wagering game fails to meet a threshold outcome;
determining a change to the expected value of the wagering game corresponding to the provided option;
charging the player a cost relating to the determined change in the expected value;
randomly determining an outcome of the wagering game.

22. A method of conducting a wagering game according to claim 21, further comprising:
awarding an award to the player relating to the randomly determined outcome if the outcome of said wagering game meets or exceeds said threshold outcome.

23. A method of conducting a wagering game according to claim 22, further comprising:
replaying the wagering game if the randomly determined outcome of said wagering game fails to meet said threshold outcome.

24. A method of conducting a wagering game according to claim 22, further comprising:
replaying the wagering game, if the randomly determined outcome of said wagering game fails to meet said threshold outcome, until the outcome of said wagering game meets or exceeds said threshold outcome.

25. A method of conducting a wagering game according to claim 22, further comprising:
returning at least a portion of the cost charged to the player if the randomly determined outcome of said wagering game fails to meet said threshold outcome.
